(19) United States
(12) Patent Application Publication
(10) Pub. No.: US 2022/0222689 A1
(43) Pub. Date: Jul. 14, 2022

(54) METHODS AND APPARATUS FOR SURGE-ADJUSTED FORECASTING

(71) Applicant: Walmart Apollo, LLC, Bentonville, AR (US)

(72) Inventors: Anirban Chatterjee, West Bengal (IN); Smaranya Dey, Dumdum (IN); Subhadip Paul, Howrath (IN); Uddipto Dutta, Dundum (IN); Vijay Srinivas Agneeswaran, Bellandur (IN)

(21) Appl. No.: 17/513,818

(22) Filed: Oct. 28, 2021

(30) Foreign Application Priority Data
Dec. 11, 2020 (IN) 202031054031

(51) Int. Cl. G06Q 30/02; G06Q 10/04; G06Q 10/06; G06Q 10/10; G06N 5/04

(52) U.S. Cl. CPC G06Q 30/0202; G06Q 10/04; G06N 5/04; G06Q 10/06315; G06Q 10/109; G06Q 10/06311

(57) ABSTRACT

This application relates to apparatus and methods for automatically predicting values for a future time period based on time series data of a previous time period. In some examples, a computing device employs multiple algorithms or predictions models to determine baseline predictions and bias predictions accounting for both normal and surge-induced events in the future time period. Accuracy of the algorithms and exogenous variables, such as holidays, events, temporal indicators, are leveraged to accurately predict future values. Baseline predictions using baseline algorithms are aggregated with bias predictions associated with surge events to determine final predictions for the future time period without compromising on the accuracy and efficiency of the predictions for both normal and surge-induced events.

### CROSS-REFERENCE TO RELATED APPLICATIONS

This application claims benefit to Indian Patent Application No. 202031054031 filed Dec. 11, 2020.

### TECHNICAL FIELD

The disclosure relates generally to determining surge-adjusted forecasting and, more specifically, to electronically determining and providing surge-adjusted forecast predictions for events in stores and online retail locations.

### BACKGROUND

At least some retailers determine inventory of an item to be kept in stores (e.g., brick-and-mortar stores) or warehouses through historical store and online volume of customers at particular locations (e.g., physical locations, web-based locations, etc.), on particular days and/or times. Further, some retailers determine scheduling workforce (e.g., number of employees in stores and warehouses) on any given day based on the historical store and online data. Sometimes, retailers may decide to adjust the size of the inventory and/or workforce in stores. For example, during holiday season, the retailer may increase the inventory and the workforce in stores and warehouses. As another example, if a new item is to be released that is anticipated to bring up volume of customers to stores and retailer website, the retailer may increase the number of employees scheduled to work in the corresponding stores and warehouses. As such, there are opportunities to address the determination of expected volume of customers when attempting to determine an inventory to maintain and scheduling workforce in stores and warehouses on any given day.

### SUMMARY

The embodiments described herein are directed to automatically determining and providing forecasted predictions for a customer volume in stores or online when attempting to stock inventory and/or schedule workforce in stores or warehouses. The embodiments employ one or more forecasting models, such as statistical models, Bayesian structural models, and machine learning models, to determine the initial predictions for a future time period, and performing bias correction to adjust the initial predictions for extreme surges or events to determine surge-adjusted predictions for the future time period. In some examples, the embodiments also determine when and how to schedule inventory and/or workforce for the future time period based on the customer volume predictions.

In some examples, the embodiments may determine how to stock items such as to avoid insufficient or excess inventory of the items. Similarly, in some examples, the embodiments may determine how many employees to schedule on any given future day and/or time such as to avoid insufficient or excess employees at the stores or warehouses to assist with stocking, assisting customers, and selling items. As such, the embodiments allow a retailer to stock items and schedule workforce efficiently during both normal or stationary days, and during surges or downturns. For example, the embodiments may allow a retailer to predict customer volume such that all days and times of customer volume surges and downturns are accounted for, and the retailer can optimize inventory and scheduling for any given day and time while increasing (e.g., maximizing) revenue and customer satisfaction throughout the future time period. In addition to or instead of these example advantages, persons of ordinary skill in the art having the benefit of these disclosures may recognize and appreciate other advantages as well.

In accordance with various embodiments, exemplary systems may be implemented in any suitable hardware or hardware and software, such as in any suitable computing device. For example, in some embodiments, a computing device employs artificial intelligence, such as machine learning models, statistical models, structural models, to forecast predictions for customer volume for a future time period. For example, the computing device may employ a first forecasting model that determines first forecasted predictions, based on time series data for a previous time period (e.g., a previous year, a previous month, etc.), that indicate baseline predictions for the future time period. The computing device may also employ a point process model (i.e., bias prediction model) to generate second forecasted predictions, based on the time series data, that indicate surges in predictions at high intensity or event days or time within the future time period. The computing device may also employ a prediction optimization model that aggregates the first and the second forecast predictions to determine the final predictions for the future time period. The predictions may then be used to stock inventory and/or schedule workforce for stores or warehouses.

In some embodiments, a computing device is configured to receive a prediction request for a future time period. The computing device may also be configured to obtain time series data for a previous time period from a database. The computing device may be configured to determine first predictions for the future time period using at least a subset of the time series data (e.g., time series data portions with values below a predetermined threshold). The computing device may be further configured to determine second predictions for the future time period (e.g., for time series data portions with values above the predetermined threshold or another predetermined threshold). For example, the first predictions may be with respect to a stationary component of the time series data. Similarly, the second predictions may be with respect to shock components of the time series data. The computing device may aggregate the first and second predictions to determine final forecast predictions for the future time period such that both stationary and surge signals are accounted for. The computing device may be configured to present the final forecast predictions.

In some examples, the computing device is configured to apply a plurality baseline prediction models to the time series data to generate the first predictions. The baseline prediction models include statistical models, Bayesian structures models, machine learning models (e.g., neural network models). The baseline prediction models may use time series values associated with stationary signals that are mostly consistent throughout the time series data. In such examples, the first predictions may be based on an accuracy associated with each of the baseline models used to generate the predictions.

In some examples, the computing device is configured to apply a point process model (i.e., bias or surge prediction model) to generate the second predictions for time series values associated with spikes or surges (e.g., abrupt fluctuation in values) in the time series data. The point process model may be based on several exogenous variables and corresponding times, such as but not limited to, holiday indicators, events indicators (e.g., sporting events), and temporal indicators. The computing device may be configured to generate the second predictions based on a probability of a high intensity spike in a prediction value at each interval in the future time period.

In some embodiments, a method is provided that includes receiving a request for predictions for a future time period. The method also includes obtaining time series data for a previous time period from a database. The method includes determining first predictions for the future time period using at least a subset of the time series data (e.g., time series data portions with values below a predetermined threshold). The method further includes determining second predictions for the future time period (e.g., for time series data portions with values above the predetermined threshold or another predetermined threshold). For example, the first predictions may be with respect to a stationary component of the time series data. Similarly, the second predictions may be with respect to shock components of the time series data. The method may include aggregating the first and second predictions to determine final forecast predictions for the future time period such that both stationary and surge signals are accounted for. The method may also include presenting the final forecast predictions.

In some examples, the method may include applying a plurality baseline prediction models to the time series data to generate the first predictions. The baseline prediction models may include statistical models, Bayesian structures models, machine learning models (e.g., neural network models). The baseline prediction models may use time series values associated with stationary signals that are mostly consistent throughout the time series data. In such examples, the first predictions may be based on an accuracy associated with each of the baseline models used to generate the predictions.

In some examples, the method may also include applying a point process model to generate the second predictions for time series values associated with spikes or surges (e.g., abrupt fluctuation in values) in the time series data. The point process model may be based on several exogenous variables and corresponding times, such as but not limited to, holiday indicators, events indicators (e.g., sporting events), and temporal indicators. The method may include generating the second predictions based on a probability of a high intensity spike in a prediction value at each interval in the future time period.

In yet other embodiments, a non-transitory computer readable medium has instructions stored thereon, where the instructions, when executed by at least one processor, cause a computing device to perform operations that include receiving a request for predictions for a future time period. The operations may also include obtaining time series data for a previous time period from a database. The operations may also include determining first predictions for the future time period using at least a subset of the time series data (e.g., time series data portions with values below a predetermined threshold). The operations may further include determining second predictions for the future time period (e.g., for time series data portions with values above the predetermined threshold or another predetermined threshold). For example, the first predictions may be with respect to a stationary component of the time series data. Similarly, the second predictions may be with respect to shock components of the time series data. The operations may include aggregating the first and second predictions to determine final forecast predictions for the future time period such that both stationary and surge signals are accounted for. The operations may also include presenting the final forecast predictions.

In some examples, the operations include applying a plurality baseline prediction models to the time series data to generate the first predictions. The baseline prediction models include statistical models, Bayesian structures models, machine learning models (e.g., neural network models). The baseline prediction models may use time series values associated with stationary signals that are mostly consistent throughout the time series data. In such examples, the first predictions may be based on an accuracy associated with each of the baseline models used to generate the predictions.

In some examples, the operations may include applying a point process model to generate the second predictions for time series values associated with spikes or surges (e.g., abrupt fluctuation in values) in the time series data. The point process model may be based on several exogenous variables and corresponding times, such as but not limited to, holiday indicators, events indicators (e.g., sporting events), and temporal indicators. The operations may also include generating the second predictions based on a probability of a high intensity spike in a prediction value at each interval in the future time period.

### BRIEF DESCRIPTION OF THE DRAWINGS

The features and advantages of the present disclosures will be more fully disclosed in, or rendered obvious by the following detailed descriptions of example embodiments. The detailed descriptions of the example embodiments are to be considered together with the accompanying drawings wherein like numbers refer to like parts and further wherein:

FIG. 1 is a block diagram of a surge-adjusted forecasting system in accordance with some embodiments;

FIG. 2 is a block diagram of the prediction forecasting computing device of the surge-adjusted forecasting system of FIG. 1 in accordance with some embodiments;

FIG. 3 is a block diagram illustrating examples of various portions of the surge-adjusted forecasting system of FIG. 1 in accordance with some embodiments;

FIG. 4 is a block diagram illustrating examples of various portions of the prediction forecasting computing device of FIG. 1 in accordance with some embodiments;

FIG. 5 is a flowchart of an example method that can be carried out by the price determination computing device of FIG. 2 in accordance with some embodiments; and

FIG. 6 is a flowchart of another example method that can be carried out by the price determination computing device of FIG. 2 in accordance with some embodiments; and

### DETAILED DESCRIPTION

The description of the preferred embodiments is intended to be read in connection with the accompanying drawings, which are to be considered part of the entire written description of these disclosures. While the present disclosure is susceptible to various modifications and alternative forms, specific embodiments are shown by way of example in the drawings and will be described in detail herein. The objectives and advantages of the claimed subject matter will become more apparent from the following detailed description of these exemplary embodiments in connection with the accompanying drawings.

It should be understood, however, that the present disclosure is not intended to be limited to the particular forms disclosed. Rather, the present disclosure covers all modifications, equivalents, and alternatives that fall within the spirit and scope of these exemplary embodiments. The terms “couple,” “coupled,” “operatively coupled,” “operatively connected,” and the like should be broadly understood to refer to connecting devices or components together either mechanically, electrically, wired, wirelessly, or otherwise, such that the connection allows the pertinent devices or components to operate (e.g., communicate) with each other as intended by virtue of that relationship.

The embodiments described herein employ models such as statistical models, structural models, machine learning models (e.g., deep learning models, neural networks), to determine predictions of values for a future time period based on time series data including values in a previous or prior time period. For example, the embodiments may employ a baseline forecasting model and a point process model (i.e., bias prediction model). The baseline forecasting model may forecast first predictions that predict values for the future time period that define a global structure (e.g., stationary component) of the predictions for the future time period. For example, the forecasting model may predict values for the future time period based on a subset of the time series data with values below a predetermined threshold that defines the stationary component of the time series data. The point process model or the bias prediction model may forecast second predicts that predict values for the future time period that define a local structure (e.g., predicted surges, spikes, etc.) for the future time period. For examples, the point process model or the bias prediction model may predict values for the future time period based on exogenous variables, such as holidays, sporting events, item release, etc. The point process mold may generate the second predictions based on a probability of a high intensity spike in a prediction value at each interval in the future time period As such, the baseline forecasting model and the point process model together may predict values corresponding to events at a particular store or website during a particular future period of time by aggregating the first and the second predictions. The store may be one of a plurality of stores operated by a retailer, for example. The period of time can be a month, a season, a holiday, a holiday season, or any other period of time. The embodiments may leverage the baseline forecast model and the point process model to predict values for both the normal events (e.g., global structure, stationary component), and the extreme events (e.g., surges, spikes) for the future time period.

For example, a forecasting model engine may receive an indication of a future time period needing predictions of values (e.g., orders, volume of customers, items, stocking, employees, etc.) for a particular store(s) or website(s). The forecasting model engine may receive or obtain time series data include values corresponding to a previous time period from a database. The forecasting prediction model may determine a subset of the time series data that corresponds to the global structure of the time series data, such that, only values below a predetermined threshold are included in the subset.

The baseline forecasting model(s) (e.g., statistical models, Bayesian structural models, neural networks, machine learning models, etc.) may obtain the subset of time series data. The one or more baseline forecasting models may then predict baseline predictions (e.g., first predictions) for the future time period using at least the subset of the time series data. The baseline predictions may indicate values corresponding to a global structure of the predictions corresponding to the future time period.

The point process model (i.e., bias prediction model) may obtain the time series data from the database. The point process model may then predict bias or surge predictions (e.g., second predictions) for the future time period indicating surges in predictions at high intensity or event days or time within the future time period. The point process model may utilize one or more exogenous variables, such as but not limited to, holiday indicators, weather indicators, event indicators, sporting event indicators, item release indicators, etc.

The forecasting model engine may aggregate the baseline predictions and the bias or surge predictions to determine final predictions for the future time periods. In some examples, the values in the baseline predictions and the corresponding values in the bias or surge predictions for associated time or day of the future time period may be combined or added to determine the final predictions. The forecasting model engine may provide, using a communications interface, the final predictions for presentation at a computing device, via a graphical user interface. In some examples, the final predictions may be used to stock and/or schedule workers at the corresponding store(s) or warehouses(s). For example, additional workers may be scheduled to work at the store(s) and/or warehouses during days with high values. In some examples, the workforce scheduling and/or the item stocking may be linearly based on the values predicted for each day or time in the future predictions. The forecasting model engine may perform the above-described operations automatically at every predefined interval (e.g., day, week, month, etc.) without prompt from a user.

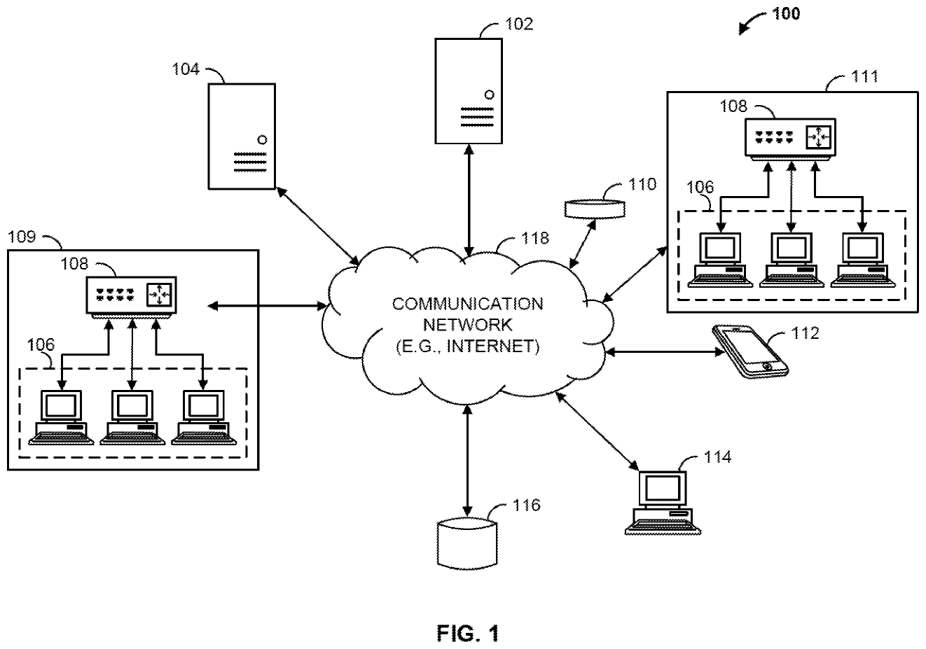

Turning to the drawings, FIG. 1 illustrates a block diagram of surge-adjusted forecasting system 100 that includes a prediction forecasting computing device 102 (e.g., a server, such as an application server), a web server 104, workstations 106, database 116, and multiple customer computing devices 110, 112, 114 operatively coupled over network 118. Prediction forecasting computing device 102, workstation(s) 106, server 104, and multiple customer computing devices 110, 112, 114 can each be any suitable computing device that includes any hardware or hardware and software combination for processing and handling information. For example, each can include one or more processors, one or more field-programmable gate arrays (FPGAs), one or more application-specific integrated circuits (ASICs), one or more state machines, digital circuitry, or any other suitable circuitry. In addition, each can transmit data to, and receive data from, communication network 118.

In some examples, prediction forecasting computing device 102 can be a computer, a workstation, a laptop, a server such as a cloud-based server, or any other suitable device. In some examples, each of multiple customer computing devices 110, 112, 114 can be a cellular phone, a smart phone, a tablet, a personal assistant device, a voice assistant device, a digital assistant, a laptop, a computer, or any other suitable device. In some examples, prediction forecasting computing device 102 is operated by a retailer, and multiple customer computing devices 112, 114 are operated by customers of the retailer.

Workstations 106 are operably coupled to communication network 118 via router (or switch) 108. Workstations 106 and/or router 108 may be located at one of a first store 109 or second store 111, for example. Workstations 106 can communicate with prediction forecasting computing device 102 over communication network 118. The workstations 106 may send data to, and receive data from, prediction forecasting computing device 102. For example, the workstations 106 may transmit data related to an order purchased by a customer at first store 109 (or second store 111) to prediction forecasting computing device 102.

In some examples, prediction forecasting computing device 102 may determine and transmit predictions, such as predicted values (e.g., number of orders, item stocking, employees, etc.), to workstations 106. For example, prediction forecasting computing device 102 may receive from first store 109 (e.g., via workstation 106) a request for predictions for a future time period for first store 109. Prediction forecasting computing device 102 may determine the predictions, and transmit data indicating the predictions to first store 109. The predictions may then be utilized to stock items and/or schedule employees at first store 109.

Web server 104 can be any suitable computing device that can host a website, such as an online marketplace. For example, web server 104 can a website for a retailer that sells items online, such as a retailer's online marketplace. The website may allow a customer to view and purchase items. For example, the website may display the items, along with a price for each item. The website may allow the customer to purchase the item for the displayed price. In some examples, the item is shipped to the customer (e.g., to an address provided by the customer). In some examples, the website may allow the customer to pick up the items at a store location, such as at first store 109 or second store 111.

In some examples, prediction forecasting computing device 102 receives from web server 104 a request for predictions for a future time period for the website hosted by web server 104. Prediction forecasting computing device 102 may determine the predictions, and transmit data indicating the predictions to web server 104. The predictions may then be utilized to stock items and/or schedule employees at warehouse(s) and/or stores(s) associated with the web server, as indicated by the retailer to fulfill the online orders.

In some examples, web server 104 transmits user transaction data and user interaction data for one or more customers to predicted forecasting computing device 102 for the previous or prior time period. User transaction data may identify, for example, purchase transactions (e.g., the purchase of items) made by the customers on a website hosted by web server 104. User interaction data may identify, for example, user visits, clicks, add to cards, etc., made by the customer on a website hosted by web server 104. The user transaction data and user interaction data may then be used by the predicted forecasting computing device 102 as time series data.

First customer computing device 110, second customer computing device 112, and N^{th} customer computing device 114 may communicate with web server 104 over communication network 118. For example, each of multiple computing devices 110, 112, 114 may be operable to view, access, and interact with webpages of a website hosted by web server 104. In some examples, web server 104 hosts a website for an online marketplace of a retailer that allows for the purchase of items. The website may display items for sale, as well as the prices to purchase the items. A customer operating of one of multiple computing devices 110, 112, 114 may access the website hosted by web server 104, add one or more items to an online shopping cart of the website, and perform an online checkout of the shopping cart to purchase the items.

Although FIG. 1 illustrates three customer computing devices 110, 112, 114, surge-adjusted forecasting system 100 can include any number of customer computing devices 110, 112, 114. Similarly, surge-adjusted forecasting system 100 can include any number of web servers 104, stores 109, 111, workstations 106, prediction forecasting computing devices 102, and databases 116.

Prediction forecasting computing device 102 is operable to communicate with database 116 over communication network 118. For example, prediction forecasting computing device 102 can store data to, and read data from, database 116. Database 116 can be a remote storage device, such as a cloud-based server, a memory device on another application server, a networked computer, or any other suitable remote storage. Although shown remote to Prediction forecasting computing device 102, in some examples, database 116 can be a local storage device, such as a hard drive, a non-volatile memory, or a USB stick.

Communication network 118 can be a WiFi network, a cellular network such as a 3GPP® network, a Bluetooth® network, a satellite network, a wireless local area network (LAN), a network utilizing radio-frequency (RF) communication protocols, a Near Field Communication (NFC) network, a wireless Metropolitan Area Network (MAN) connecting multiple wireless LANs, a wide area network (WAN), or any other suitable network. Communication network 118 can provide access to, for example, the Internet.

In some examples, prediction forecasting computing device 102 receives a request from workstation 106 at, for example, first store 109, to determine predictions for a future time period based on time series data associated with a previous or prior time period of first store 109. The request may identify a type of prediction (e.g., orders, items, employees, etc.) and, in some examples, a period of time for the future time period for when the predictions are requested. The period of time may be a month of the year, a season, a holiday, a holiday season, a date range, or any other period of time. The request may, in some examples, also identify a previous time period to base the future predictions on. In some examples, the request may be automatically sent at predetermined intervals (e.g., every day, week, month, etc.). In some other examples, the prediction forecasting computing device 102 may automatically generate predictions at the predetermined intervals without input or request from workstation 106. The predetermined intervals may be provided by the retailer of first store 109, via workstation 106.

In response to receiving the request, prediction forecasting computing device 102 may obtain time series data associated with the type of requested prediction for the previous time period. For example, the time series data may be stored in database 116. The time series data identifies and characterizes the type of data with respect to time based previous transactions (e.g., orders, sales), previous volume of customers, previous number of employees, etc. resulting from data collected from first store 109 during the previous time period. For example, the time series data may identify previous transactions at first store 109 and/or second store 111. The stores may be a subset (e.g., a small subset such as 5%, all stores, 50%) of all stores for a retailer. The time series data may also include or only include previous inventory data for the stores, such as store inventories for each of a plurality of store(s) during the previous time period.

Prediction forecasting computing device 102 may execute a forecasting model (e.g., forecasting algorithm) to generate item demand data indicating a predicted demand for the item at first store 109. For example, price determination computing device 102 may implement the forecasting model to map a price-time-demand relationship. The predicted demand may include an amount (e.g., number) of the item predicted to be sold over a period of time, such as over the period of time received in the request. The predicted demand is specific to a particular store. For example, a predicted demand for an item over a period of time at first store 109 may not be the same as a predicted demand for the item over the same period of time at store 111.

Prediction forecasting computing device 102 may provide the forecasting model engine with the time series data as input and may execute the forecasting model engine to generate the predictions for the future time period. The forecasting model engine may be based, for example, on machine learning algorithms, statistical analysis algorithms, Bayesian structural algorithms, etc. In some examples, the forecasting model engine is provided with time series data that includes one or more of historical transaction data for purchases of items, historical user interaction data (e.g., customer volumes, add to carts, item reviews), historical store workforce scheduling data, at a particular store(s), such as first store 109 and second store 111. The historical transaction data may also identify store inventory levels of the items when the transactions were executed.

Once time series data is generated or obtained, prediction forecasting computing device 102 may execute a forecasting model engine to generate predictions for the requested future time period. The forecasting model engine may include a plurality of forecasting models, such as models based on machine learning algorithms, statistical analysis algorithms, Bayesian structural algorithms, for example. Prediction forecasting computing device 102 may provide the forecasting model engine with the generated or obtained time series data for the previous time period, and the future time period as input. Based on one or more of the time series data, historical transaction data, and the future period of time received in the request, execution of the forecasting model engine accurately and efficiently generates predictions for the future time period indicating future predicted values for the type of predictions requested, with accurate predictions for both normal events and surges during the future time period.

In some examples, the forecasting model engine may utilize one or more baseline prediction models and a bias prediction model (e.g., point process model) to generate the future predictions. The forecasting model engine may provide the baseline prediction model(s) with the time series data and the future time period as input. In some examples, the forecasting model engine may determine a subset of time series data that includes values in the time series data below a predetermined threshold indicating a global structure (e.g., normal events, stationary component) of the time series data. The predetermined threshold value may be a fixed value provided by workstation 106 of first store 109 or may be determined based on a statistical analysis of all values in the time series data to extract surges or spikes from the time series data.

Baseline prediction model(s) may receive at least the subset of the time series data and the future time period as input, to generate or determine baseline predictions (e.g., first predictions) for the future time period with an increased accuracy for the global structure of the future time period. The baseline prediction models may include any known forecasting models, such as but not limited to, classical statistical models, Bayesian structural models, neural-network based models (e.g., deep neural networks, convolutional neural networks). In some examples, two or more baseline prediction models may be used to determine the baseline predictions. In some examples, the baseline model with the highest accuracy (e.g., lowest mean absolute percentage error) may be used to determine the baseline predictions. In other examples, the predictions of the two or more baseline prediction models may be aggregated based on the respective accuracy to determine the baseline predictions for the future time period. For example, predictions from n baseline models may be aggregated based on their respective accuracy, accᵢ, to generate the baseline predictions, F_{baseline}, as follows:

$$\begin{matrix}{F}_{baseline} = {\sum }_{i = 1}^{n} ( \frac{{acc}_{i}}{{\sum }_{{acc}_{i}}} {F}_{i} ) & ( eq . 1 ) \\ {acc}_{i} = \frac{1}{{MAPE}_{i}} & ( eq . 2 )\end{matrix}$$

where Fᵢ is the forecast (i.e., predictions) generated using the i^{th} model, and MAPEᵢ corresponds to the mean absolute percentage error of the i^{th} model

In some examples, the forecasting model engine may provide the time series data and the future time period to the bias prediction model as input. The bias prediction model may detect abrupt fluctuations (e.g., surges, spikes) in the time series data using any known statistical analysis. The bias prediction model may be a point process model that adjusts the baseline predictions to account for the abrupt fluctuations. The bias prediction model may use an intensity parameter that is based on a plurality of exogenous variables and time. The intensity parameter may determine for every predicted fluctuation, when next fluctuation will occur in the future time period. Exogenous variables may include one or more of holiday indicators, events indicators (e.g., sporting events, religious events), item releases, temporal indicators, etc. As such, the intensity parameter, λₜ, may be defined as follows:

λₜ=ƒ(x₁_{ₜ},x₂_{ₜ}, . . . xₖ_{ₜ}) (eq. 3)

where t indicates time, xₖ_{ₜ} indicates an exogenous variable as a function of time, and k indicates the total number of exogenous variables at time t. In such examples, a probability, IP{N(t)=n}, of an abrupt fluctuation at time, t, in the future time period may be determined using a nonhomogeneous point Poisson process, as follows:

$$\{ N ( t ) = n \} = \frac{{λ}_{t}^{n}}{n !} {e}^{- {λ}_{t}} \qquad ( eq . 4 )$$

where N(t) denotes a number of abrupt fluctuations up to time, t, and n denotes the number of variables up to time, t.

In some examples, when the probability of an abrupt fluctuation is above a predetermined threshold probability (e.g., 0.5, 0.7), for a time, a bias prediction is generated for that time. The bias predictions may then include 0 for each time except for the ones with probabilities higher than the predetermined threshold probability that indicate abrupt fluctuations at the corresponding times. In some examples, the bias predictions for times with detected abrupt fluctuations may be a predetermined prediction value. In other examples, the bias predictions for times with detected abrupt fluctuations may be dependent on corresponding surge values in the time series data of the previous time period. The bias prediction model may provide the bias predictions to the forecasting model engine for aggregation with the baseline predictions.

In some examples, the forecasting model engine may aggregate the baseline predictions and the bias predictions to determine or generate the final predictions for the future time period. For examples, for each time, the values from the baseline predictions may be added to the values of the bias predictions to generate the final predictions for the future time period. Under this multi-stage environment, predictions can be accurately and efficiently made in real-time for both normal and surge induced events in the future time period without compromising the accuracy of the baseline models for the normal events.

In some examples, execution of the forecasting model engine also generates future time series data indicating the final predictions for the future time period. Prediction forecasting computing device 102 may transmit the final predictions for the future time period to web server 104, and web server 104 may cause presentation of the final prediction on an interface of a computing device. Further, web server 104 or other portions of the first store 109 may generate stocking and/or workforce scheduling data for first store 101 based on the final predictions. For example, more employees may be scheduled for a time where final predictions show a surge. As another example, more items may be stocked prior to or at the time where final predictions show a surge.

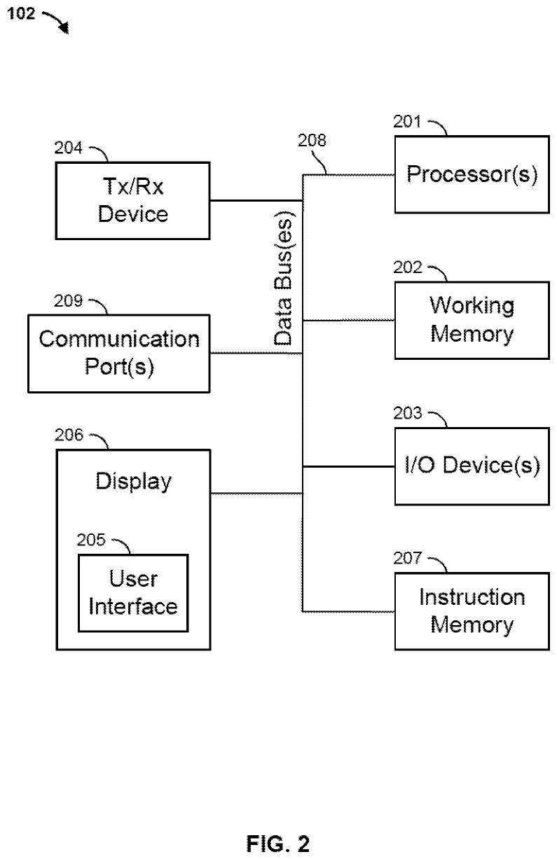

FIG. 2 illustrates the prediction forecasting computing device 102 of FIG. 1. Prediction forecasting computing device 102 can include one or more processors 201, working memory 202, one or more input/output devices 203, instruction memory 207, a transceiver 204, one or more communication ports 209, and a display 206, all operatively coupled to one or more data buses 208. Data buses 208 allow for communication among the various devices. Data buses 208 can include wired, or wireless, communication channels.

Processors 201 can include one or more distinct processors, each having one or more cores. Each of the distinct processors can have the same or different structure. Processors 201 can include one or more central processing units (CPUs), one or more graphics processing units (GPUs), application specific integrated circuits (ASICs), digital signal processors (DSPs), and the like.

Processors 201 can be configured to perform a certain function or operation by executing code, stored on instruction memory 207, embodying the function or operation. For example, processors 201 can be configured to perform one or more of any function, method, or operation disclosed herein.

Instruction memory 207 can store instructions that can be accessed (e.g., read) and executed by processors 201. For example, instruction memory 207 can be a non-transitory, computer-readable storage medium such as a read-only memory (ROM), an electrically erasable programmable read-only memory (EEPROM), flash memory, a removable disk, CD-ROM, any non-volatile memory, or any other suitable memory.

Processors 201 can store data to, and read data from, working memory 202. For example, processors 201 can store a working set of instructions to working memory 202, such as instructions loaded from instruction memory 207. Processors 201 can also use working memory 202 to store dynamic data created during the operation of prediction forecasting computing device 102. Working memory 202 can be a random access memory (RAM) such as a static random access memory (SRAM) or dynamic random access memory (DRAM), or any other suitable memory.

Input-output devices 203 can include any suitable device that allows for data input or output. For example, input-output devices 203 can include one or more of a keyboard, a touchpad, a mouse, a stylus, a touchscreen, a physical button, a speaker, a microphone, or any other suitable input or output device.

Communication port(s) 209 can include, for example, a serial port such as a universal asynchronous receiver/transmitter (UART) connection, a Universal Serial Bus (USB) connection, or any other suitable communication port or connection. In some examples, communication port(s) 209 allows for the programming of executable instructions in instruction memory 207. In some examples, communication port(s) 209 allow for the transfer (e.g., uploading or downloading) of data, such as machine learning algorithm training data.

Display 206 can display user interface 205. User interfaces 205 can enable user interaction with prediction forecasting computing device 102. For example, user interface 205 can be a user interface for an application of a retailer that allows a customer to view and interact with a retailer's webpage. In some examples, a user can interact with user interface 205 by engaging input-output devices 203. In some examples, display 206 can be a touchscreen, where user interface 205 is displayed on the touchscreen.

Transceiver 204 allows for communication with a network, such as the communication network 118 of FIG. 1. For example, if communication network 118 of FIG. 1 is a cellular network, transceiver 204 is configured to allow communications with the cellular network. In some examples, transceiver 204 is selected based on the type of communication network 118 prediction forecasting computing device 102 will be operating in. Processor(s) 201 is operable to receive data from, or send data to, a network, such as communication network 118 of FIG. 1, via transceiver 204.

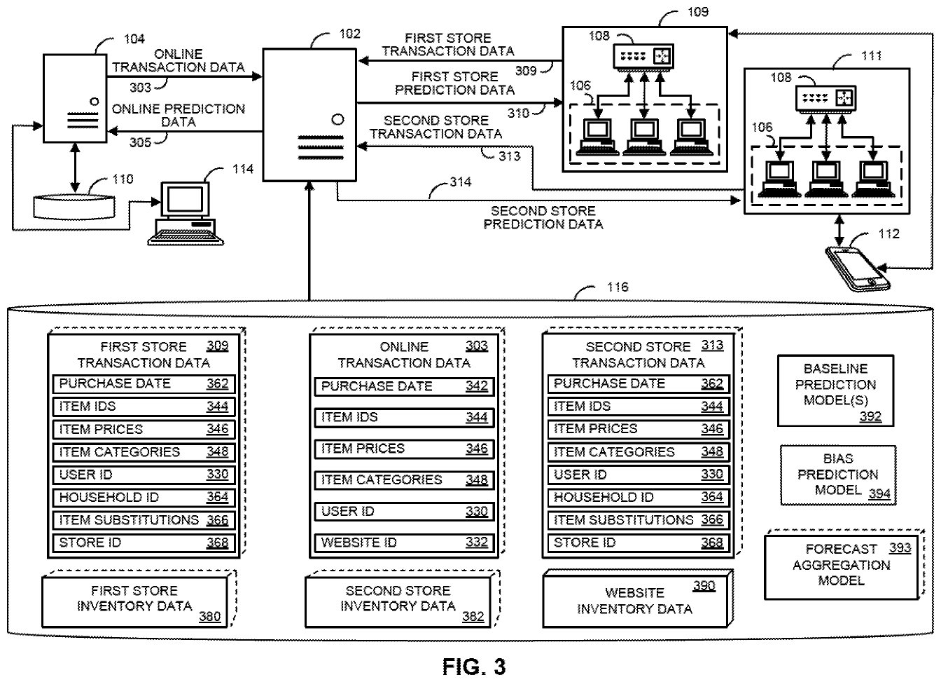

FIG. 3 is a block diagram illustrating examples of various portions of the surge-adjusted forecasting system 100 of FIG. 1. As illustrated in FIG. 3, prediction forecasting computing device 102 can receive first store transaction data 309 from store 109. First store transaction data 309 may identify and characterize purchase transactions conducted by customers at first store 109 within first time period. In some examples, the customers may pay for purchased items with one of multiple customer computing devices 110, 112, 114. For example, the customers may pay using a retailer's application executing on one of multiple customer computing devices 110, 112, 114. First store transaction data 309 may include, for each transaction, a purchase date 342, item IDs 344, item prices 346, item categories 348 (e.g., a category and/or subcategory for each item), a user ID 330, a household ID 364 (e.g., an address, a phone number, or any other household identifier), item substitutions 366 (e.g., an item that was substituted for an original item (e.g., due to being out of stock), and a store ID 368. Prediction forecasting computing device 102 may aggregate and store first store transaction data 309 in database 116. In some examples, the first store transaction data 309 may also include a number or volume of people, and number of employees in store 309.

Similarly, predicted forecasting computing device 102 may receive second store transaction data 313 from second store 111. Prediction forecasting computing device 102 may similarly aggregate and store second store transaction data 313 in database 116.

Predicted forecasting computing device 102 may also receive online transaction data 303 from web server 104. Online transaction data 303 may identify and characterize purchase transactions made and user interaction performed by customers on a website hosted by web server 104. For example, a customer may access a retailer's online marketplace hosted by web server 104 using one of multiple customer computing devices 110, 112, 114. The online marketplace may display items, and prices of items. The online marketplace may further allow the customer to purchase or interact with (e.g., click, add to cart) one or more items for the advertised prices. For each purchase transaction and interaction, web server 104 may generate and transmit online transaction data 303. Online transaction data 303 can include, for example, a purchase date 342, item IDs 344, item prices 346, item categories 348, a user ID 330, and a website ID 332 (e.g., a website IP address or URL). Prediction forecasting computing device 102 may aggregate online transaction data 303 for each website, and store the aggregated online transaction data 303 in database 116.

Prediction forecasting computing device 102 may further store first store inventory data 380 in database 116. First store inventory data 380 identifies current and previous inventory levels of items at first store 109. First store inventory data 380 may also identify a current price of an item, and a current inventory level for the item.

Similarly, prediction forecasting computing device 102 may store second store inventory data 382 in database 116, which identifies current and previous inventory levels of items at second store 111. Prediction Forecasting computing device 102 may further store website inventory data 390 in database 116, which identifies current and previous inventory levels of items sold on the corresponding website.

As illustrated in FIG. 3, database 116 stores baseline prediction model(s) 392, bias prediction model 394, and forecast aggregation engine 393. In some examples, baseline prediction model(s) 392 identifies and characterizes one or more of a statistical, a Bayesian structural, and a neural network (e.g., machine learning) algorithms that, when executed, generates baseline predicted data. The baseline predicted data may identify predicted baseline values for a particular store or website, for example, for a future time period. Baseline prediction model(s) 392 may operate on one or more store inventory (such as first store inventory data 380 or second store inventory data 382), online transaction data 303, first store transaction data 309, second store transaction data 313, and/or website inventory data 390, over a previous time period to generate the baseline predicted data. Predicted forecasting computing device 102 is operable to obtain baseline prediction model(s) 392 from database 116 and execute baseline prediction model(s) 392 to generate the baseline predicted data for the future time period.

In some examples, bias prediction model 394 identifies and characterizes one or more of a statistical or a stochastic algorithms that, when executed, generates bias predicted data. The bias predicted data may identify predicted biased values for a particular store or website, for example, for a future time period, indicating abrupt fluctuations predicted based on exogenous variables. Bias prediction model 394 may operate on one or more store inventory (such as first store inventory data 380 or second store inventory data 382), online transaction data 303, first store transaction data 309, second store transaction data 313, and/or website inventory data 390, over a previous time period to generate the bias predicted data. Predicted forecasting computing device 102 is operable to obtain bias prediction model 394 from database 116 and execute bias prediction model 394 to generate the bias predicted data for the future time period.

In some examples, forecast aggregation engine 393 identifies and characterizes an aggregation algorithm to aggregate the baseline predicted data and the bias predicted data. The forecast aggregation engine 393 may identify final predictions for the future time period for a particular store or website, for example. Forecast aggregation engine 292 may operate on one or more of the baseline predicted data and the bias predicted data generated by the baseline prediction model(s) 392 and bias prediction model 394, respectively, to generate the final predictions for the future time period.

Prediction forecasting computing device 102 is operable to obtain baseline prediction model(s) 392, bias prediction model 394, and forecast aggregation engine 393 from database 116, and execute them to generate the final predictions for the future time period. Predicted forecasting computing device 102 may then transmit the final predictions. For example, if determining final predictions for a first store 109, prediction forecasting computing device 102 may generate first store prediction data 310 identifying and characterizing the final predictions and may transmit first store prediction data 310 to first store 109. The item stocking and/or workforce schedule may be updated or generated by first store 109.

If determining final predictions for second store 111, prediction forecasting computing device 102 may generate second store prediction data 314 identifying and characterizing the final predictions for the future time period, and may transmit second store prediction data 314 to second store 111. The item stocking and/or workforce schedule may be updated or generated by first store 111.

Likewise, if determining final predictions for a website hosted by web server 104, prediction forecasting computing device 102 may generate online prediction data 305 identifying and characterizing the final predictions for the future time period, and may transmit online prediction data 305 to web server 104. Web server 104 may generate or update the item stocking and/or workforce schedule for associated warehouse(s).

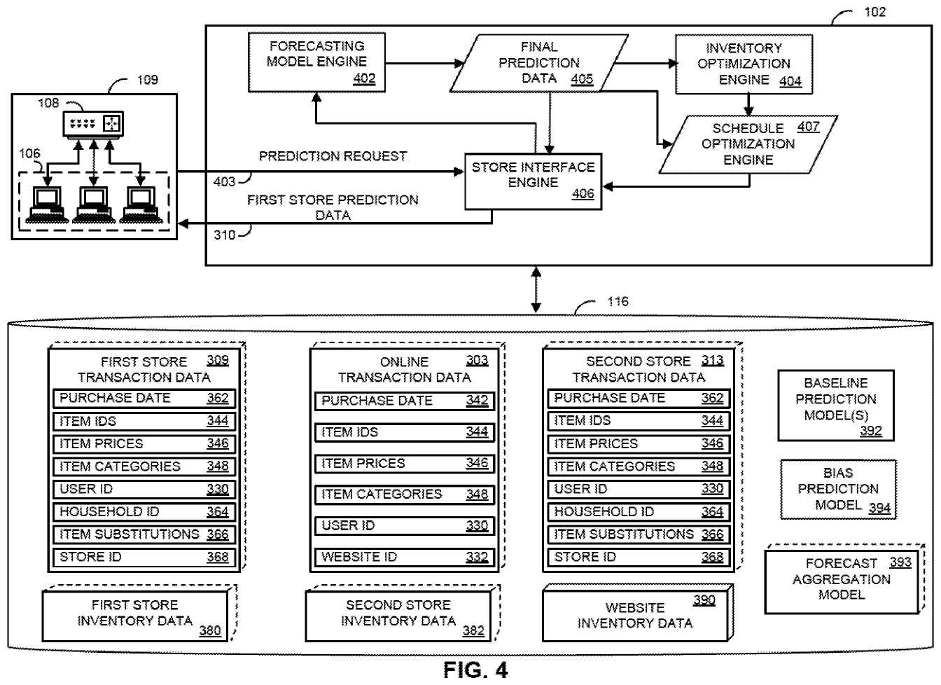

FIG. 4 is a block diagram illustrating a more detailed view of predicted forecasting computing device 102. Specifically, predicted forecasting computing device 102 includes forecasting model engine 402, inventory optimization engine 404, store interface engine 406, and schedule optimization engine 407. In some examples, one or more of forecasting model engine 402, inventory optimization engine 404, store interface engine 406, and schedule optimization engine 407 are implemented in hardware. In some examples, one or more of forecasting model engine 402, inventory optimization engine 404, store interface engine 406, and schedule optimization engine 407 are implemented as an executable program maintained in a tangible, non-transitory memory, such as instruction memory 207 of FIG. 2, which may be executed by one or processors, such as processor 201 of FIG. 2. For example, forecasting model engine 402 may obtain from database 116 baseline forecasting model(s) 392, and may execute prediction model(s) 392. Similarly, forecasting model engine 404 may obtain from database 116 bias predication model 394, and may execute bias prediction model 394.

In this example, first store 109 (e.g., via workstations 106) transmits a prediction request 403 to predicted forecasting computing device 102. Prediction request 403 a future time period for which the predictions are requested. In some examples, prediction request 403 further identifies one or more of a type of predictions (e.g., orders, items, inventories, employees) requested at first store 109, and/or a previous time period from which to forecast the predictions. Store interface engine 406 receives prediction request 403, and parses and extracts the data received. Store interface engine 406 provides to the forecasting model engine 402 the extracted data, which may include the time series data extracted from database 116.

Forecasting model engine 402 can determine final predictions for the future time period for first store 109 based on the time series data generated from one or more of first store transaction data 309, and first store inventory data 380 from the previous time period. Forecasting model engine 402 generates final prediction data 405 identifying and characterizing the final predictions for the future time period for first store 109, and provides final prediction data 405 to inventory optimization engine 404 and/or schedule optimization engine 407.

Inventory optimization engine 404 can determine an inventory required for items for one or more times of the future time period based on final prediction data 405, and one or more of first store transaction data 320, and a current inventory level of the items at first store 309. Inventory optimization engine 404 may optimize inventory in store 109 based on abrupt fluctuations in the final prediction data 405 on any given time interval of the future time period. In some examples, inventory optimization engine 404 may optimize inventory in a linear fashion where higher values in the final predictions correspond to higher inventory.

Similarly, schedule optimization engine 407 can determine a schedule of employees required for one or more times of the future time period based on final prediction data 405, and one or more of first store transaction data 320, and a current inventory level of the items at first store 309. Schedule optimization engine 407 may optimize scheduling of employees for store 109 based on abrupt fluctuations in the final prediction data 405 on any given time interval of the future time period. In some examples, schedule optimization engine 407 may optimize scheduling of employees in a linear fashion where higher values in the final predictions correspond to more employees being scheduled.

Store interface engine 406 may receive final prediction data 405, scheduling data, and/or inventory data into a data format (e.g., message) acceptable by first store 109 as identified by first store prediction data 310. Store interface engine 406 transmits first store prediction data 310 to first store 109. First store 109 may then update or generate scheduling and/or inventory data for the future time period based on the first store predicted data 310.

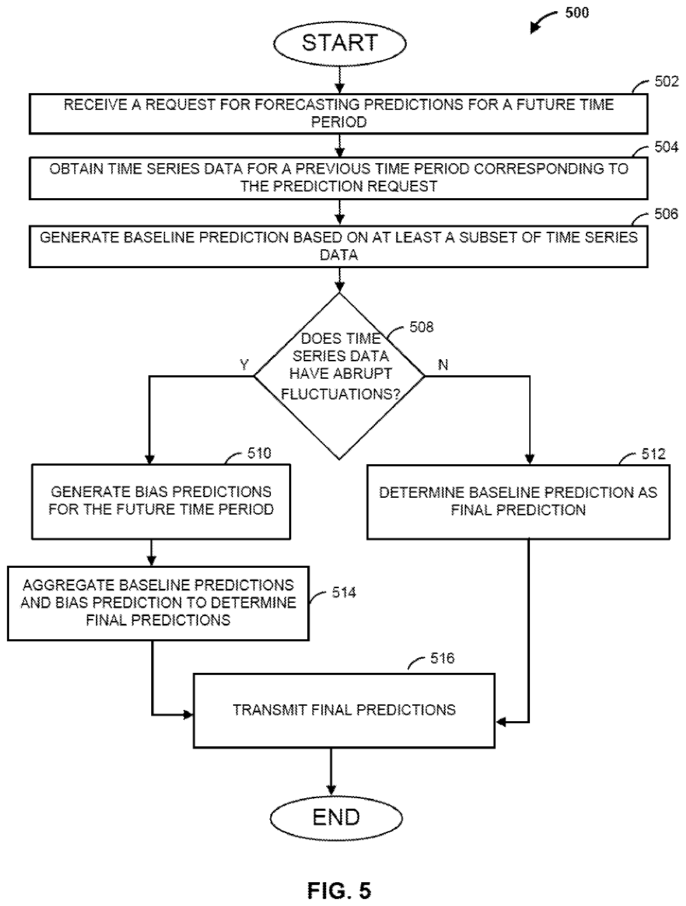

FIG. 5 is a flowchart of an example method 500 that can be carried out by surge-adjusted forecasting system 100 of FIG. 1. Beginning at step 502, a request for forecasting predictions for a future time period is received. For example, predicted forecasting computing device 102 may receive prediction request 403 from first store 109. At step 504, time series data for a previous time period corresponding to the prediction request is obtained from a database. For example, prediction forecasting computing device 102 may obtain first store transaction data 309 and/or first store inventory data 380 for a previous time period from database 116. At step 506, baseline predictions are generated based on at least a subset of the time series data. For example, the baseline prediction model(s) 392 may be used to generate baseline prediction based on the subset of time series data corresponding to values lower than a predetermined threshold (e.g., global structure of time series data). In some examples, prediction forecasting computing device 102 may obtain first store inventory data 380 and first store transaction data 309 to determine the time series data of the pervious time period.

Proceeding to step 508, whether the time series data has abrupt fluctuations is determined. The abrupt fluctuations may correspond to spikes or surges in values in the time series data. For example, predicted forecasting computing device 102 may determine whether there are values in the time series data corresponding to abrupt fluctuation. At step 510, based on determining that the time series data has abrupt fluctuations, bias predictions are generated for the future time period. For example, predicted forecasting computing device 102 may obtain bias prediction model 394 to generate the bias predictions for the future time period based on the time series data corresponding to the previous time period.

At step 512, the baseline predictions are presented as final predictions in response to determining that the time series data does not include abrupt fluctuations. At step 514, the baseline predictions and bias predictions are aggregated to generate final predictions for the future time period. For example, forecast aggregation engine 393 may aggregate the baseline predictions generated by the baseline prediction model(s) 392 and the bias predictions generated by the bias prediction model 394 to generate final prediction data 405. At step 516, the final predictions for the future time period are transmitted. For example, predicted forecasting computing device 102 may generate first store prediction data 310 identifying the final predictions for the future time period for first store 109, and transmit first store prediction data 310 to first store 109. The method then ends.

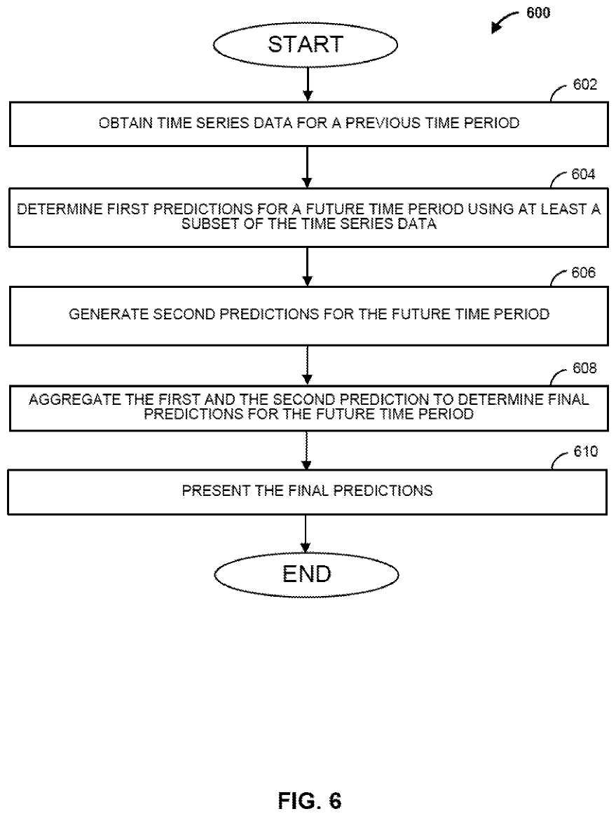

FIG. 6 is a flowchart of another example method 600 that can be carried out by the surge-adjusted forecasting system 100 of FIG. 1. Beginning at step 602, time series data for a previous time period is obtained. For example, prediction forecasting computing device 102 may obtain first store transaction data 309 and/or first store inventory data 380 for a previous time period from database 116. At step 604, first predictions for a future time period are generated using at least a subset of the time series data. For example, the baseline prediction model(s) 392 may be used to generate baseline predictions (i.e., first predictions) based on the subset of time series data corresponding to values lower than a predetermined threshold (e.g., global structure of time series data). In some examples, prediction forecasting computing device 102 may obtain first store inventory data 380 and first store transaction data 309 to determine the time series data of the pervious time period.

Proceeding to step 606, second predictions are generated for the future time period. For example, predicted forecasting computing device 102 may obtain bias prediction model 394 to generate the bias predictions (i.e., second predictions) for the future time period based on the time series data corresponding to the previous time series data. The second predictions may be generated to account for abrupt fluctuations (e.g., spikes, surges) based on exogenous variables. At step 608, the first and the second predictions are aggregated to determine final forecast predictions for the future time period. For example, forecast aggregation engine 393 may aggregate the baseline predictions generated by the baseline prediction model(s) 392 and the bias predictions generated by the bias prediction model 394 to generate final prediction data 405.

At step 610, final forecast predictions are presented via a user interface. The method then ends.

Although the methods described above are with reference to the illustrated flowcharts, it will be appreciated that many other ways of performing the acts associated with the methods can be used. For example, the order of some operations may be changed, and some of the operations described may be optional.

In addition, the methods and system described herein can be at least partially embodied in the form of computer-implemented processes and apparatus for practicing those processes. The disclosed methods may also be at least partially embodied in the form of tangible, non-transitory machine-readable storage media encoded with computer program code. For example, the steps of the methods can be embodied in hardware, in executable instructions executed by a processor (e.g., software), or a combination of the two. The media may include, for example, RAMs, ROMs, CD-ROMs, DVD-ROMs, BD-ROMs, hard disk drives, flash memories, or any other non-transitory machine-readable storage medium. When the computer program code is loaded into and executed by a computer, the computer becomes an apparatus for practicing the method. The methods may also be at least partially embodied in the form of a computer into which computer program code is loaded or executed, such that, the computer becomes a special purpose computer for practicing the methods. When implemented on a general-purpose processor, the computer program code segments configure the processor to create specific logic circuits. The methods may alternatively be at least partially embodied in application specific integrated circuits for performing the methods.

The foregoing is provided for purposes of illustrating, explaining, and describing embodiments of these disclosures. Modifications and adaptations to these embodiments will be apparent to those skilled in the art and may be made without departing from the scope or spirit of these disclosures.

What is claimed is:

1. A system comprising:
a computing device configured to:
obtain time series data for a previous time period;
generate first predictions for a future time period using at least a subset of the time series data;
generate second predictions for the future time period;
aggregate the first and the second predictions to determine final forecast predictions for the future time period; and
present the final forecast predictions.

2. The system of claim 1, wherein the subset of the time series data includes a set of time series values below a predetermined threshold value.

3. The system of claim 1, wherein time series data includes values corresponding to a number of orders received by a retailer per day.

4. The system of claim 1, wherein the computing device is further configured to apply at least two baseline prediction models to the time series data to generate the first predictions.

5. The system of 4, wherein generating the first predictions is further based at least in part on an accuracy associated with each of the at least two baseline prediction models.

6. The system of claim 5, wherein the accuracy associated with each of the at least two baseline models is based on a mean absolute percentage error of the corresponding baseline prediction model.

7. The system of claim 1, wherein the bias second predictions are generated based at least in part on one or more exogenous parameters associated with the future time period.

8. The system of claim 7, wherein the one or more exogenous parameters include variables associated with one or more of holiday indicators, events indicators, and temporal indicators.

9. The system of claim 1, wherein generating the second predictions is based on a second subset of the time series data including values above a predetermined threshold associated with high intensity spikes.

10. The system of claim 1, wherein generating the second predictions is based on a probability of a high intensity spike in a prediction value at each interval in the future time period.

11. The system of claim 1, wherein aggregating the first and the second predictions includes applying a summing function to add a first value of the first prediction and a second value of the second prediction for corresponding each interval of the future time period r.

12. The system of claim 1, wherein aggregating the first and the second predictions is based on an accuracy associated with an algorithm used to generate the first predictions and another algorithm used to generate the second predictions.

13. A method comprising:
obtaining time series data for a previous time period, the time series data including a plurality of intervals with a stationary time series values and one or more intervals with high intensity spike values;
generate first predictions for a future time period using a first subset of the time series data including the plurality of intervals with stationary time series values;
generate second predictions using a second subset of the time series data including the one or more intervals with the high intensity spike values;
aggregate the first and the second predictions to determine final forecast predictions for the future time period; and
cause to present the final forecast predictions.

14. The method of claim 13, wherein the high intensity spike values include values corresponding to intervals of the time series data that are above a predetermined spike threshold value.

15. The method of claim 13, wherein the first predictions are generated using at least two algorithms that are selected from a plurality of algorithms based on the time series data and an accuracy associated with each of the two algorithms.

16. The method of claim 13, wherein aggregating the first and the second predictions is based on an accuracy associated with algorithms used to predict each of the first predictions and the second prediction.

17. The method of claim 13, wherein aggregating the first and the second predictions is based on the high intensity spike values in the second subset of time series data.

18. The method of claim 13, further comprising performing an operation based on the final forecast predictions, the operation including one of ordering one or more items, generating an employee schedule, or stocking one or more items.

19. The method of claim 13, wherein the time series data includes values corresponding to a number of employees scheduled to work per day.

20. A non-transitory computer readable medium having instructions stored thereon, wherein the instructions, when executed by at least one processor, cause a device to perform operations comprising:
obtaining time series data for a previous time period;
generating first predictions for a future time period using at least a subset of the time series data;
generating second predictions for the future time period;
aggregating the first and the second predictions to determine final forecast predictions for the future time period; and
causing to present the final forecast predictions.
